(19) United States
(12) Patent Application Publication
(10) Pub. No.: US 2003/0217807 A1
(43) Pub. Date: Nov. 27, 2003

(54) Method and apparatus for gluing

(76) Inventors: Leif Lesmann, Herfolge (DK); Sofie Keiler, Nacka (SE)

Correspondence Address: David J. Serbin, Unit 2, First Floor, 1423 Powhatan Street, Alexandria, VA, 22314, US

(21) Appl. No.: 10/351,318

(22) Filed: Jan. 27, 2003

Related U.S. Application Data
(60) Provisional application No. 60/354,299, filed on Feb. 7, 2002.

(30) Foreign Application Priority Data
Jan. 25, 2002 (EP) 02445010.8

(51) Int. Cl. B32B 31/04

(52) U.S. Cl. 156/310; 156/547; 156/331.3

(57) ABSTRACT

A method of joining at least two objects (2,4) by gluing with a two-component adhesive system to form a composite structure is disclosed. It comprises providing a first adhesive component including liquid urea-formaldehyde in combination with a powdery urea, so as to render the first component sufficiently viscous. Furthermore, a second adhesive component including a hardener is provided. At least one of the objects (4) is preheated prior to joining said objects. The first and second adhesive components are then applied separately to said objects. Finally, heat and pressure (14) is applied for a time sufficient to cause said adhesive to cure.

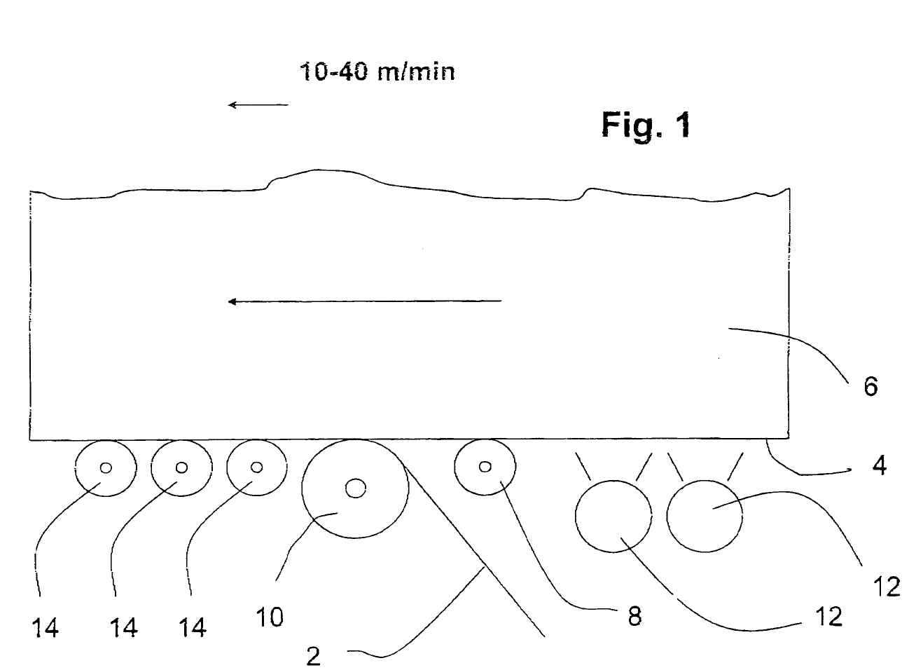

The present invention relates generally to gluing of objects to form composite structures, and in particular to attaching edge bands to a planar edge of structures or objects such as panels.

### BACKGROUND OF THE INVENTION

Edgebanding is a process whereby a strip of material, for the art in question referred to as an “edgeband”, is applied to cover the side edge of a flat panel. This can be done to cover exposed laminations, to create a more substantial panel appearance by attaching a thick edge, or to decorate the edge with a more finished or contrasting appearance. The edgebands can be of a variety of materials including wood, polyvinyl chloride (PVC), acrylic, laminates, etc.

It has been known to use hot melt adhesives in automated edgebanding for a significant decrease in fabrication time. By “hot melt adhesive” is meant an adhesive that is applied in the molten state and forms a bond upon cooling to a solid state. Such adhesives are characterized in that they can be melted and remelted numerous times. These adhesives are typically based on ethylene vinyl acetate. However, such hot melt adhesives generally do not provide an acceptable bond with non-porous surfaces. In addition, materials such as Corian® solid surface with significant thermal mass tend to extract heat from the hot melt adhesive line and effectively raise the viscosity of the adhesive. This can produce an edgeband seam that is both functionally and aesthetically unsatisfactory.

A process for edgebanding according to the present state of the art is disclosed in U.S. Pat. No. 6,112,794, which improves the prior process by providing heating and employing a reactive adhesive, such as a reactive polyurethane hot melt adhesive. Use of polyurethane is associated with certain environmental problems. For example can isocyanate, which is a compound that is hazardous to the health, be released in hot environments

However, even with this improved process the quality of the glue joint is not satisfactory, and in particular problems arise with cold creep. The cold creep phenomenon manifests itself in that the glue becomes brittle in cold and softens in hot and humid environments, because the hot melt adhesives used are thermoplastic materials. This phenomenon will be apparent during transport across sea, where the cargo may become exposed to very humid and hot environments; in tropical regions temperatures of up to 70° C. can be reached in the cargo space of ships. Edgebands may easily come off the structures to which they are attached if the glue is softened due to such exposure.

Conventional amino resin type glues cannot be used in conventional edgebanding production facilities because these glues require too long pressing times, and it is not possible to allow such long pressing times in the conventional lines of manufacture. The production speed would have to be reduced to an unacceptable level.

### SUMMARY OF THE INVENTION

In view of the problem with the prior art methods and devices, there is a need in the market for still improved properties of the glue joint in e.g. edgebanding, board on frame or parquetting processes. Therefore it is the object of the present invention to provide a novel method by which the shortcomings of the currently used methods are overcome. In a first aspect this is achieved by the process defined in claim 1. Thereby the process comprises providing a first component, including liquid urea-formaldehyde having a dry matter content of 70-85%; preheating said first component to a temperature of 40-100° C. prior to joining said objects; providing a second component including a hardener comprising a mixture of monobasic or polybasic organic and/or inorganic acids, said mixture exhibiting a pH<4, and said acids suitably having pKₐ values in the range −3-7; applying said first and second adhesive components separately to said objects; joining said objects to an assembly, to bring said first component and said second component in contact with each other; and applying heat and pressure across said assembly for a time sufficient to cause said adhesive to cure. The novelty aspect of the invention is to employ amino resin based glue systems, in contrast to the prior art, wherein normally thermoplastic hot melt adhesives have been used, the glue system being designed so as to allow very short pressing times, around 1 second or even shorter.

The decisive factors are i) use of an efficient hardener system, ii) control of the rheological properties during application of the glue, and iii) separate application of glue and hardener.

A further factor that enhances performance is preheating of the glue prior to applying it to the substrates (e.g. edgebands and panels), and optionally also preheating of the substrates.

The rheology of the composition, which is crucial during the manufacturing process, e.g. edge-banding, is controlled by employing a glue with a high content of dry matter, and by tuning the application temperature to the dry matter content in order to arrive at a suitable rheology of the glue during application.

The desired dry matter content can be achieved in a preliminary step of mixing, and the mixture can be conveyed to the application station.

In an alternative embodiment a liquid glue ingredient is mixed in a controlled manner with a 100% dry (powder) ingredient, to achieve the desired dry matter content, and thus the desired rheology, immediately prior to application.

A major advantage of the invention is the superior quality of the glue joint, compared to prior art edgebanding, by virtue of the use of amino resin based adhesive, which is a prepolymer forming a cross-linked material when cured, i.e. a non-thermoplastic resin.

In a second aspect the invention provides an apparatus for joining at least two objects by gluing with a multi-component adhesive system to form a composite structure, comprising a conveyor for moving a first object and a second object to be joined, past a gluing station; said gluing station comprising contacting means for bringing said objects in contact with each other; a glue applicator for applying glue to one of objects prior to bringing the objects in contact with each other; heating means for preheating a first glue component prior to bringing the objects in contact with each other; pressure rollers provided after the contacting means.

### BRIEF DESCRIPTION OF THE DRAWINGS

The invention will now be described with reference to examples and the drawing FIGURE, which is a schematic illustration of an edgebanding process embodying the present invention.

### DETAILED DESCRIPTION OF THE INVENTION

Although the inventive concept is applicable to a plurality of different processes of manufacture (see Example 1-3), the invention will now be illustrated in general terms as applied to edgebanding.

The invention is based on the use of a multi-component adhesive system comprising glue and hardener, where each component is applied either separately to the objects to be joined, or wet in wet on one of the objects, but supplied from separate spreaders.

The FIGURE illustrates schematically a machine for applying an edge band 2 to the edge 4 of a fiber/chip board 6, e.g. a shelf element or a table top. The machine comprises a conveyor (not shown) for moving an object 6 (e.g. a fiber board) to be provided with an edgeband 2, past a gluing station. The gluing station comprises a guide roll 10 for guiding an edge band 2 onto the object 6. It also comprises a glue applicator roll 8 (although other types of applicators are possible). There are provided heating means 12 for preheating the object 6, and pressure rolls 14 that can be heated to provide the required process pressure and temperature.

The fiber board 6 is advanced through the machine at a suitable speed of about 10-40 m/min, preferably 20-30 m/min. A glue applicator 8 of standard type can be used, e.g. suitable applicator rollers or a spreader nozzle, for applying the glue component to the edge 4.

The edge band 2 to be attached on the edge 4 of the board 6, is supplied from supply rollers (not shown) that are unwound and the band 2 is directed towards the edge 4 of the board via suitable guiding tools, such as a guide roll 10. The band can be provided with the hardener component either by a separate applicator (not shown) just prior to bringing it into contact with the board edge, or the band can be pretreated with hardener and even supplied from the deliverer in this pretreated condition.

An important aspect of the inventive process is pre-heating of the glue before the edge band is brought into contact with the board edge.

Thus, several points in the system can be subjected to pre-heating. The board edge itself can be preheated by suitable means 12, such as by subjecting it to a flow of hot air or exposing it to radiant heat energy, at a position just prior to the point where glue is applied to the edge.

The edge band, provided with hardener, can be preheated at 350° C., e.g. by blowing hot air onto the surface thereof, just prior to contacting it with the board edge. The glue composition can also preferably be preheated before application thereof, and the applicator roll can also be heated, to facilitate the process. A suitable temperature of application for the glue is 50-100° C.

Suitably, a heated (e.g. 200° C.) roller 10 is used to guide the edge band and press it against the board edge, as illustrated in the figure. A plurality of additional pressure rollers 14 can be provided to supply a necessary pressure for a sufficiently long time to achieve the required quality of the joint (by “sufficiently long time” we mean a pressing time of the order of magnitude of 1 second and shorter). These additional rollers 14 can suitably also be heated at about 200° C., but the temperature could be in the range 100-250° C., preferably 120-180° C.

Now the gluing system will be described in some detail with reference to each component separately.

For the purpose of this application the term “component” of the gluing system according to the invention shall be taken to mean that which actually is applied to a surface of objects to be joined by gluing. That is, if two separate constituents or ingredients are mixed just prior to application they are nevertheless regarded as one “component”.

In a preferred embodiment of the method according to the invention, the adhesive system is applied as a two-component system, i.e. a first component in the form of a liquid glue having a suitable dry matter content is applied to one substrate, and a hardener is applied to another substrate, and the two substrates are joined. Of course it is possible to apply additional components separately, and such modifications are within the inventive concept.

Individual components of the gluing system will now be described in more detail.

The Liquid Glue

The liquid glue ingredient, is basically an amino resin pre-polymer of e.g. urea and formaldehyde, melamine and formaldehyde or a co-condensate of melamine, urea and formaldehyde, wherein the polymerization process has been terminated, by raising the pH of the reaction mixture, e.g. by the addition of a base. Mixtures of these pre-polymers are also usable and within the inventive concept.

This liquid amino resin prepolymer can include straight chain oligomers and also cyclic oligomers. The liquid pre-polymer contains dry matter at about 50-85%, preferably 60-70%, i.e. it is an aqueous solution of 60-70% by weight of oligomer, and has a Formaldehyde/Urea (F/U) molar ratio of 0,9-2,0, preferably 1,3-1,7.

The rheological properties of the glue is important. Of course these properties depend i.a. on temperature. On one hand, the viscosity must be suitable for e.g. edgebanding applications, i.e. attaching the edgebands onto the edges of a panel or board, at the temperatures employed in this process. Too low viscosity will tend to cause fauling of the apparatus, and cause uneven application on the vertical surfaces, since the liquid easily flows off the surface. Too high viscosity will make it difficult to control the amount of glue that is to be applied.

The viscosity of a typical liquid glue is 400 mPas at 40° C., and 200 mPas at 60° C. respectively (by Brookfield LVT, sp3, rpm 30).

Secondly, the viscosity and temperature must be suitable for the mixing process, i.e. the mixing of liquid glue ingredient and powder glue ingredient.

The Powder

The powder ingredient of the glue composition can be a spray dried amino resin prepolymer of e.g. urea and formaldehyde, melamine and formaldehyde or a co-condensate of melamine, urea and formaldehyde, wherein the polymerization process has been terminated (e.g. a spray-dried liquid glue). Mixtures of these pre-polymers are also usable and within the inventive concept. The F/U molar ratio for the powder ingredient is suitably 1,3-2,0.

The composition of the two-/(multi-) component adhesive system to be employed in accordance with the invention can be varied within certain limits. In particular the dry matter content and the molar ratio of formaldehyde to urea (F/U molar ratio) are used as measures to control the properties.

If it is assumed that the powder ingredient has a dry matter content of 100%, and a molar ratio of 1,74, and the liquid has a dry matter content of 65% and a molar ratio of 1.575 (it is preferably in the range 1,3-1,7), the molar ratios of the mixtures at 60:40 (liquid/powder) and 80:20, respectively, will be in the range 1.62-1.74.

The Hardener

The hardener must meet certain requirements, e.g it must provide an acidic pH in order to properly catalyze the curing/cross-linking reaction. Suitably the pH is 0-3, preferably <0,4. To meet this requirement it preferably contains organic or inorganic, monobasic or polybasic carboxylic acids, exhibiting pKₐ values in the range −3-7. It should allow for very rapid hardening/curing, i.e., within 2 seconds, preferably within 1 second, in the applications in question.

Suitable organic acids can be selected from formic acid, citric acid, maleic acid, para-toluene sulfonic acid (PTSS), succinic acid, fumaric acid, oxalic acid, adipic acid, malonic acid, glutaric acid, glycolic acid, methane sulfonic acid, 4-phenol sulfonic acid, and mixtures thereof.

Inorganic acids could be sulphamic acid, phosphoric acid, hydrochloric acid, and mixtures thereof.

Gluing

Before application of the glue component, suitably the liquid glue and the powder ingredient are mixed.

In order that mixing of glue (liquid) and powder be more easily performed, the liquid glue should be kept at a temperature of at least 40° C. It would be advantageous if a higher temperature can be used. However, at about 70° C. of the liquid, the powder ingredient forms aggregates during admixing, which renders the process more difficult. Therefore, a suitable and preferred temperature would be 40-60° C.

The viscosity of a typical mixture is 60000 mPas at 40° C., and 16000 mPas at 70° C. respectively (by Brookfield LVT, sp4, rpm 3).

It can be noted that storage of the ingredients at elevated temperatures is not possible over any extended period of time. The powder will aggregate, and the liquid tends to form a gel.

There is a tradeoff between the need for low viscosity during mixing and a suitable and higher viscosity for the application of the glue composition. The glue must be sufficiently viscous in order not to flow outside the edges of the boards, but also not too viscous because then it will be difficult to apply. At the same time the temperature must be sufficiently high to enable the glue to harden in cooperation with the separately applied hardener.

The final dry matter content of the glue mixtures depends on the mixing ratio. The following are examples of three different mixtures and the dry matter content that results in each case:

| Mixing ratio (liquid/powder) | Dry matter content (%) |
|---|---|
| 60/40 | 76.9 |
| 70/30 | 74.5 |
| 80/20 | 71.3 |

A suitable range for the dry matter content for the purpose of the invention is 70-85%, preferably 70-77%.

The hardener used in the examples below exhibits a pH<3, and suitably contains a mixture of monobasic or polybasic organic and inorganic acids, exhibiting pKₐ values in the range −3-7, preferably 0-7, most preferably 1-7. In particular two acids were used in a mixture, the pKₐ of said acids being 1.05 (sulphamic acid), 1.83 and 6.07 (maleic acid, di-basic), respectively.

The above description relates to the use of a liquid and a powder ingredient to make a suitable glue having the correct and desirable dry matter content. This is of course a convenient approach in that the desired dry matter content can be produced on demand by suitably selecting the mixing ratios.

It is also possible to admix powder dispersions into UF system which increases the viscosity of the system. This can be an advantage from a machine utilization point of view, but also from a gluing technical point of view. E.g. in operation of the machine, the glue composition by virtue of it being highly viscous would stay on the surfaces, i.e. would not spill over the edges. A gluing technical advantage would be that the glue stays on the edge surface (e.g. of the board), instead of being sucked up into the board edge, which means that there would be more glue available to the edge band to adhere to. Furthermore, the glue would act more like a putty compound, levelling out any irregularities present on the surface. The dispersion would improve the flexibility of the system, thereby rendering the joints less brittle. Flexibility of the system can be a great advantage from a machine utilization point of view, since the edge bands in production are cut off to correct size only a few seconds after having been attached to the edge of the board. If the glue joint is too brittle during cutting there is a risk that the edge band comes off.

Water based dispersion can be admixed instead of powder dispersions. This will in principle correspond to liquid glue and powder glue (powder glue must be mixed with water in order to be usable).

Dispersion are binders (glue) in themselves, i.e. they are used alone in certain gluing applications, and so, apart from reacting into and with the UF system, it can have its own effect. The dispersions are often relatively fast, i.e. harden quickly, which for the purpose of the present invention is an advantage. Dispersions will often yield a softer glue joint compared to UF glue which is a hard and frequently brittle binder, and therefore a UF system with these dispersions admixed would yield a more flexible or accommodating glue joint. Commonly dispersions are tacky and exhibits good initial “bite”, which is an advantage for edge-banding.

The admixture of the dispersion to the UF composition preferably is done at the same time and in the same way as the admixture of the powder glue to the liquid glue is done, therefore no substantial change in equipment is required. Some kind of mixer is required for mixing together the desired glue mixture before it is filled into the edge banding machine.

The polymer in the dispersion usable in the invention is suitably a homopolymer or copolymer prepared from one or more ethylenically unsaturated monomers. Examples of suitable ethylenically unsaturated monomers are vinylic monomers, such as vinyl esters, e. g., vinyl acetate, vinyl propionate, vinyl butyrate and comonomers thereof with, e. g., ethylene alkyl esters of acrylic and methacrylic acid such as methyl acrylate, methyl methacrylate, ethyl acrylate, n-butyl acrylate, etc.; butadiene-styrene and derivates thereof, such as carboxylated butadiene-styrene; substituted or unsubstituted mono-and dialkyl esters of alpha, beta-unsaturated dicarboxylic acids such as the substituted and unsubstituted mono-and dibutyl, mono-and diethyl maleate esters as well as the corresponding fumarates, itaconates and citronates; alpha beta-unsaturated carboxylic acids such as crotonic, acrylic and methacrylic acids and mixtures thereof. Polymers based on vinyl acetate are preferred. Preferably the polymer is prepared from at least 50 weight % vinyl acetate, based on the total weight of the monomers.

The dispersion polymer may comprise post-crosslinking groups. The post-crosslinking groups can be incorporated into the polymer by copolymerising one or more ethylenically unsaturated monomers with at least one monomer comprising at least one post-crosslinking group. Suitable post-crosslinking groups include N-alkylol, N-alkoxymethyl, carboxylate and glycidyl groups.

By post-crosslinking monomer is herein meant a monomer having a first reactive functional group that renders the monomer copolymerisable with ethylenically unsaturated comonomer (s) and a second functional group that does not enter into the copolymerisation reaction during formation of the polymer, but provides a reactive site on the copolymer that may subsequently be reacted under, for example, acidic conditions, with another reactive site on the copolymer and/or the amino resin to crosslink the copolymer and/or the amino resin.

Suitable post-crosslinking monomers include, N-alkylol acrylamides, e. g., Nmethylol acrylamide, N-ethanol acrylamide, N-propanol acrylamide, N-methylol methacrylamide, N-ethanol methacrylamide, N-propanol methacrylamide, N-methylol maleamide, N-methylol maleamic acid, N-methylol maleamic acid esters; the N-alkylol amides of the vinyl aromatic acids, such as N-methylol-p-vinylbenzamide and the like ; also N-(alkoxymethyl) acrylates and methacrylates, where the alkyl group has from 1-8 carbon atoms, such as N-(methoxymethyl) acrylamide, N-(butoxymethyl) acrylamide, N (methoxymethyl) methacrylamide, N-(butoxymethyl) allyl carbamate and N (methoxymethyl) allyl carbamate, and mixtures of these monomers with allyl carbamate, acrylamide or methacrylamide; and also triallyl cyanurate. Preferably N-methylol acrylamide, or N-(butoxymethyl) acrylamide is used.

Mixtures of polymers containing post-crosslinking groups and polymers without post-crosslinking groups may also be used according to the invention. For example, the polymer may comprise both polyvinyl acetate without post-crosslinking groups and vinyl acetate based polymer containing post-crosslinking groups.

The invention is of course not restricted to a process of mixing two ingredients, but applies equally well to the use of glue already exhibiting a correct dry matter content.

The invention will now be described in further detail by way of the following non-limiting examples, which are only illustrative and shall not be construed as limiting the scope of the invention as defined by the claims.

### EXAMPLES

### Example 1

(Edgebanding)

Liquid glue ingredient (a product sold under the name Cascorit 1206 obtainable from Casco Products, Sweden) (F/U molar ratio=1.56-1.59, average 1.575) and powder glue ingredient (Cascorit 1352 obtainable from Casco Products, Sweden) (F/U ratio=1.74) was mixed by hand in a beaker in a ratio 70:30 (liquid/powder). The mixture was kept at a temperature of 70° C. for at least 3 hours before use in order to allow it to attain correct temperature. The viscosity of the mixture was 15000 mPas (by Brookfield LVT, sp4, rpm3).

Edgebands were cut to suitable dimensions and the area of each sample band was calculated. Hardener (No. 2547, obtainable from Casco Products, Sweden) was applied to the bands and the amount of hardener was determined by weighing. Using the area and the weight, the spread (g/m²) of hardener was determined. The hardener was allowed to dry for at least 30 minutes before the experiment.

The area of edges of chip boards to which the bands were to be attached was calculated to be 2,4×10⁻³ m². The chip board samples were then kept at 70° C. to attain the same temperature as the glue mixture.

For pressing a hot press (Carver) was used, and a pressing temperature of 120° C. was used, although pressing can be carried out in the range 15° C. to 130° C.

Glue was applied manually to the chip board edges, and the edge band with hardener applied to it was placed on the edge of the board. The assembly was placed in the press, and the pressing was performed as quickly as possible, about 1 second, with a pressure of about 0,8 MPa. Possible pressing times range from 0.5 seconds up to 30 minutes.

A. Paper Band

| Ex. | Hardener (g/m²) | Glue (g/m²) |
|---|---|---|
| i) | 16 | 304 |
| ii) | 20, 3 | 438 |
| iii) | 22, 5 | 458 |
| iv) | 13, 9 | 495 |

Pressing time 1 second. Bands attach very well.

B. Birch Veneer

Thickness: 0,6 mm

| Ex. | Hardener (g/m²) | Glue (g/m²) |
|---|---|---|
| i) | 30, 9 | — |
| ii) | 16, 5 | 337 |
| iii) | 18, 7 | 517 |
| iv) | 33 | 433 |

Pressing time 1 second. Bands attach well when warm.

### Example 2

(Board on Frame)

In this example a sheet of board (Dufalite®) was attached to a wooden frame by a pressing operation in a standard type press machine. Glue application was done manually. The amount of glue used was 130 g/m², which is 10 g less than commonly used. The glue was a mixture of Cascorit 1206 and Cascorit 1352 in a ratio 70:30 (w/w).

| Test | Pressing | Pressing | | |
|---|---|---|---|---|
| No. | time | temp./° C. | Comment | Result |
| 1 | 60 sec | 90 | Separate | Approved |
| | | | hardener¹⁾ on | |
| | | | board | |
| 2 | 30 sec | 90 | Separate | Approved |
| | | | hardener¹⁾ on | |
| | | | board | |
| 3 | 30 sec | 90 | Separate | Approved |
| | | | hardener¹⁾ on | |
| | | | frame and | |
| | | | dufalite | |
| 4 | 15 min | 20 (cold gluing) | Separate | Approved after |
| | | | hardener¹⁾ on | approx. 1 hour |
| | | | frame | after curing |

¹⁾Product named Hardener 2547, obtainable from Casco Products, Sweden

Tests 1-3 were evaluated just after pressing. Because it takes some time to spread the hot glue, it cools off before the pressing can be performed, and the results would probably be further improved if application time is further reduced, i.e. by machine application of the glue.

### Example 3

(Parquetting)

Standard equipment for production of parquette was used. Glue and hardener was applied wet in wet. The amount of glue used was 155 g/m², which is 15 g less than commonly used. The hardener was the same as in Example 1 and 2. The glue was a mixture of Cascorit 1206 and Cascorit 1352 in a ratio 70:30 (w/w).

| | Pressing | Pressing | | |
|---|---|---|---|---|
| Test | time | temp./° C. | Comment | Result |
| 1 | 150 sec | 105 | Separate | Approved |
| | | | hardener¹⁾ wet | |
| | | | in wet | |
| 2 | 120 sec | 105 | Separate | Approved (less |
| | | | hardener¹⁾ wet | fiber breakage) |
| | | | in wet | |
| 3 | 90 sec | 105 | Separate | Not Approved |
| | | | hardener¹⁾ wet | |
| | | | in wet | |

¹⁾Product named Hardener 2547, obtainable from Casco Products, Sweden

The tests were evaluated just after pressing. Because it takes some time to spread the hot glue, it cools off before the pressing can be performed, and penetration is decreased. The results would probably be further improved if a heated adhesive were used.

The present invention has been described with reference to certain exemplified process, but it is to be understood that the skilled man can forsee variations thereof without deviating from the scope of the invention, which is solely determined by the terms of the appended claims

1. A method of edge-banding comprising joining a panel and an edge band by gluing with a multi-component adhesive system to form a composite structure, comprising
providing a first component, including liquid urea-formaldehyde having a dry matter content of 70-85%;
preheating said first component to a temperature of 40-100° C. prior to joining said panel and said edge band;
providing a second component including a hardener comprising a mixture of monobasic or polybasic organic and/or inorganic acids, said mixture exhibiting a pH<4, and said acids suitably having pKₐ values in the range −3-7;
applying said first and second adhesive components separately to said panel and said edge band;
joining said panel and said edge band to form an assembly, to bring said first component and said second component in contact with each other; and
applying heat and pressure across said assembly for a period of time less than 1 second to cause said adhesive to cure.

2. The method as claimed in claim 1, wherein said first component is obtained by mixing a liquid urea-formaldehyde ingredient with a powder urea-formaldehyde ingredient.

3 The method as claimed in claim 2, wherein the dry matter content of the liquid urea-formaldehyde ingredient is 60-70%.

6. The method as claimed in claim 1, wherein the acids are selected from the group consisting of formic acid, citric acid, maleic acid, para-toluene sulfonic acid (PTSS), succinic acid, fumaric acid, oxalic acid, adipic acid, malonic acid, glutaric acid,glycolic acid, methane sulfonic acid, and 4-phenol sulfonic acid, sulphamic acid, phosphoric acid, hydrochloric acid, and mixtures thereof.

5. The method as claimed in claim 1, wherein the two components of the adhesive are applied either separately on said panel and said edge band, or separately but wet in wet on one of said panel and said edge band.

6. The method as claimed in claim 1, wherein the temperature of application of the adhesive is 50-100° C.

7. The method as claimed in claim 1, comprising applying the glue with an applicator roll which is heated to provide the desired application temperature.

8. The method as claimed in claim 1, comprising preheating at least one of said panel and said edge band prior to joining.

9. The method as claimed in claim 1, wherein the pressing time is from 0.5 seconds to 30 minutes, and the pressing temperature is from 15° C. to 130° C.

10. An apparatus for edge-banding comprising joining a panel and an edge band by gluing with a multi-component adhesive system to form a composite structure, comprising
a conveyor for moving a panel and an edge band to be joined, past a gluing station;
said gluing station comprising
contacting means for bringing the panel and the edge band in contact with each other for a period of time less than 1 second;
a glue applicator for applying glue to the panel prior to bringing the panel and the edge band in contact with each other;
heating means for preheating a first glue component prior to bringing the panel and the edge band in contact with each other;
pressure rollers provided after the contacting means.

11. The apparatus of claim 10, wherein said contacting means comprises an edge band guiding means for guiding an edge band onto and in contact with said panel to which the edge band is to be attached.

12. The apparatus as claimed in claim 10, wherein said rollers comprise heating means to provide an elevated temperature during the pressing operation.

13. The apparatus as claimed in claim 10, further comprising heating means for preheating at least one of said objects prior to bringing the panel and the edge band in contact with each other.

14. The apparatus as claimed in claim 11, further comprising heating means for preheating at least one of said objects prior to bringing the panel and the edge band in contact with each other.

15. The apparatus as claimed in claim 12, further comprising heating means for preheating at least one of said objects prior to bringing the panel and the edge band in contact with each other.

16. A multi-component glue system, comprising at least a first component, including liquid urea-formaldehyde having a dry matter content of 70-80%, and a second component including a hardener.

17. The glue system as claimed in claim 16, further including additive components.

18. The glue system as in claim 16, wherein the hardener comprises a mixture of monobasic or polybasic organic and/or inorganic acids, said mixture exhibiting a pH<4, and said acids suitably having pKₐ values in the range −3-7.
